(19) United States
(12) Patent Application Publication
(10) Pub. No.: US 2026/0307193 A1
(43) Pub. Date: Oct. 8, 2026

(54) METHOD FOR OPERATING AN EMERGENCY BRAKE UNIT FOR A MOTOR-DRIVEN TOOL, MONITORING UNIT, AND EMERGENCY BRAKE UNIT

(71) Applicant: Festool GmbH, Wendlingen (DE)

(72) Inventors: Markus Schmid, Uhingen (DE); Josua Frank, Urbach (DE); Christian Schock, Schorndorf (DE)

(73) Assignee: Festool GmbH, Wendlingen (DE)

(21) Appl. No.: 18/996,722

(22) PCT Filed: Aug. 3, 2023
(86) PCT No.: PCT/EP2023/071521

§ 371 Date: Jan. 17, 2025

(30) Foreign Application Priority Data
Aug. 3, 2022 (DE) 10 2022 208 077.7

(51) Int. Cl. B23Q 11/00; B27B 5/38

(52) U.S. Cl. CPC B23Q 11/0092; B27B 5/38

(57) ABSTRACT

A method operates an emergency brake unit for a motor-driven tool. The emergency brake unit has an actuator with an actuation element and at least one electrical energy storage unit. The actuation element is configured to be selectively supplied with electrical energy stored in the energy storage unit. The method detects an energy storage unit state parameter, which characterises a state of the energy storage unit. Alternatively or additionally, an actuation element state parameter is detected, which characterises a state of the actuation element. If at least one of the energy storage unit state parameter and the actuation element state parameter is outside a respectively assigned standard range, a blocking signal is triggered. In addition, a monitoring unit monitors a state of an emergency brake unit.

The invention relates to a method for operating an emergency brake unit for a motor-driven tool. The emergency brake unit has an actuator with an actuation element and at least one electrical energy storage unit, which is electrically coupled to the actuation element via an electrical switching element, in such a way that the actuation element can be selectively supplied with electrical energy stored in the energy storage unit by actuating the switching element.

The invention also relates to a monitoring unit for monitoring a state of an emergency brake unit for a motor-driven tool. The emergency brake unit has an actuator with an actuation element and at least one electrical energy storage unit, which is electrically coupled to the actuation element via an electrical switching element, in such a way that the actuation element can be selectively supplied with electrical energy stored in the energy storage unit by actuating the switching element.

The invention further relates to an emergency brake unit for a motor-driven tool with a monitoring unit of this type.

Motor-driven tools with emergency brake units are known in the art. The same applies to emergency brake units. These are used to bring a cutting element, for example a saw blade, of the tool to a standstill if contact of a user with the cutting element is imminent or is detected during operation. In this way, injuries are prevented or reduced in severity.

In this context, an actuation element is understood to be the element of the actuator by means of which the movement is generated which the actuator needs so as to act on a system actuated by the actuator, in this case the braking system. A known type of actuation element comprises a shape memory alloy. Its functionality is based on a thermally activated lattice transformation of the shape memory alloy, which leads to a change in the length of the actuation element. Actuation elements which comprise a shape memory alloy are often shaped as wires which shorten as a result of the thermally activated lattice transformation. Another known type of actuation element is a lifting magnet, in which a plunger can be displaced by electrically controlling a magnetic coil.

Actuators of this type are preferably used in reversible emergency brake units, in other words in emergency brake units which can be used multiple times to bring the cutting element to a standstill. It will be appreciated that in reversible emergency brake units the actuator must be able to be actuated multiple times with consistently high reliability.

The object of the invention is therefore to further improve known emergency brake units.

The object is achieved by a method for operating an emergency brake unit for a motor-driven tool. The emergency brake unit has an actuator with an actuation element and at least one electrical energy storage unit, which is electrically coupled to the actuation element via an electrical switching element, in such a way that the actuation element can be selectively supplied with electrical energy stored in the energy storage unit by actuating the switching element. The method comprises:
detecting an energy storage unit state parameter which characterises a state of the energy storage unit and/or an actuation element state parameter which characterises a state of the actuation element,
comparing the detected energy storage unit state parameter with an energy storage unit threshold value which limits a standard range assigned to the energy storage unit state parameter, and/or comparing the detected actuation element state parameter with an actuation element threshold value which limits a standard range assigned to the actuation element state parameter (Z2),
triggering a blocking signal if at least one of the detected energy storage unit state parameter and the detected actuation element state parameter is outside the respectively assigned standard range.

By means of the method according to the invention, the state of at least one of the energy storage unit and the actuation element is thus monitored. The actuator of the emergency brake unit and thus the emergency brake unit as a whole can only be operated if the energy storage unit state parameter or actuation element state parameter describing the state lies within a respectively associated standard range, which may also be referred to as the normal range. Otherwise, the operation of the actuator and thus of the emergency brake unit is blocked. In this way, the reliability of the emergency brake unit is increased, since it can only be operated if a corresponding state has been detected for at least one of the energy storage unit and the actuation element. This applies in particular if the emergency brake unit is an emergency brake unit which can be triggered multiple times. In this variant, it is ensured that at least one of the energy storage unit and the actuation element is in a suitable state each time it is triggered. In the case of emergency brake units which can be triggered multiple times, it may also be said in this context that an ageing state or wear state, resulting from triggering which has already occurred, is monitored. It will be appreciated that the emergency brake unit can only be operated as a function of on a state parameter which has actually been detected or received previously. There are several alternatives for triggering a blocking signal. In a first alternative, a blocking signal of this type is actively triggered when the energy storage unit state parameter and/or the actuation element state parameter is outside the respectively assigned standard range. In a case where all detected state parameters, in other words the energy storage unit state parameter and/or the actuation element state parameter, are within the standard range, no blocking signal of this type is triggered. Optionally, an active or explicit release signal may be triggered in this case. In a second alternative, an active release signal is always triggered when all detected state parameters, in other words the energy storage unit state parameter and/or the actuation element state parameter, are within the standard range. A blocking signal may be triggered simply by no longer triggering a release signal. It will also be appreciated that, depending on the type of state parameter, the assigned threshold value may limit the normal range upwards and/or downwards.

The tool may be a hand-held tool, which may also be referred to as a hand tool, a semi-stationary tool or a stationary tool.

In a preferred embodiment, the tool is a saw. This may be a hand saw, a semi-stationary saw or a stationary saw. An example of a hand saw is a portable circular saw. An example of a semi-stationary saw is a mobile table saw. An example of a stationary saw is a panel saw.

The actuation element may comprise a lifting magnet or a shape memory alloy, for example in wire form.

The electrical energy storage unit may be an electrical capacitor or a battery. It is irrelevant whether the electrical energy storage unit, in other words the capacitor or the battery, is constructed as a component of the actuator or as a component of the tool. All that matters is that the electrical energy storage unit is electrically coupled to the actuation element.

In one variant, the actuator comprises a bias element. The method may then additionally comprise:
detecting a bias element state parameter which characterises a state of the bias element,
comparing the bias element state parameter with a bias element threshold value which limits a standard range assigned to the bias element state parameter,
triggering a lock signal when the bias element state parameter is outside the normal range.

The bias element is designed in particular to transfer the actuation element into a predetermined position or location or to keep it there when the actuation element is not actuated. The bias element is for example designed as a spring. In this variant, a state of the bias element is thus monitored. This ensures that the actuator and the emergency brake unit equipped with it are only operated when the bias element is in a suitable state. As a result, the reliability of the emergency brake unit is increased.

The bias element state parameter may describe a conductivity of the bias element, and the bias element threshold value may describe a minimum permissible conductivity. The conductivity of the bias element is expediently measured between two ends of the bias element. In this example, too, the bias element may be designed as a spring, in particular as a spiral spring or leg spring made of an electrically conductive material such as metal. In this context, reduced or zero conductivity can be understood to be an indication of structural damage to the bias element. In such a case, the operation of the actuator and thus of the emergency brake unit is prevented. An illustrative example of this is a broken spiral spring made of metal, the conductivity of which is greatly reduced or no longer present as a result of the break.

The energy storage unit state parameter may also describe a number of actuation processes of the energy storage unit which have already taken place, and the energy storage unit threshold value may describe a maximum permissible number of actuation processes. Alternatively or additionally, the actuation element state parameter may describe a number of actuation processes of the actuation element which have already taken place, and the actuation element threshold value may describe a maximum permissible number of actuation processes. Actuation processes of the energy storage unit and/or of the actuation element are therefore counted and compared with a maximum number.

The maximum number may be specified as a fixed maximum number by the manufacturer of the actuator or emergency brake unit. This value is thus fixed and cannot be changed by a user either directly or indirectly.

Alternatively or additionally, the maximum number may be calculated as a function of one or more state parameters of the actuation element and/or of the energy storage unit. This results in a situational maximum number which depends on the specific ageing and/or wear of the actuator and/or of the emergency brake unit. This can be influenced at least indirectly by usage behaviour. State parameters which may be used for this purpose are an energy storage capacity of the energy storage unit or an electrical resistance of an actuation element which comprises a shape memory alloy, for example a wire made of a shape memory alloy. In a further alternative, the maximum number is not calculated as a direct function of one or more state parameters of the actuation element and/or of the energy storage unit, but rather by means of a model which calculates a maximum number on the basis of one or more state parameters of the actuation element and/or of the energy storage unit. A model of this type can be constructed on the basis of empirical data from the operation of the actuator and/or of the emergency brake unit as a whole. The empirical data includes, for example, a number of previous triggers, historical current strengths and current application periods for historical triggers, a downtime during which the emergency brake unit was out of operation and/or a downtime between two safety tests of the emergency brake unit. In all variants, it is ensured that either the emergency brake unit functions with a high degree of reliability or a blocking signal is triggered.

It will be appreciated that the threshold value which defines the maximum permissible number of actuations can also be determined as the smaller maximum permissible number of actuations out of the fixed maximum number and the situational maximum number.

In one variant, the actuation element state parameter describes a position or position difference of the actuation element, and the actuation element threshold value describes a target position or target position difference. A position difference is for example a stroke of the actuation element. The position may be an initial position or zero position of the actuation element. By monitoring the position, it is possible to determine whether the actuation element is ageing or wearing out, in such a way that a decision can be made as to whether reliable operation of the emergency brake unit is still possible. In a case where the actuation element comprises a lifting magnet, positions of the associated plunger can be determined via the inductance of the magnetic coil.

Alternatively or additionally, it is possible for the actuation element state parameter to describe an electrical resistance of the actuation element and the actuation element threshold value to describe a maximum permissible electrical resistance. The electrical resistance is considered to be an indicator of wear and/or ageing. This applies in particular in a case where the actuation element comprises a shape memory alloy. Here, structural fatigue of the shape memory alloy can be derived from an increase in electrical resistance. A temperature influence on the electrical resistance can be eliminated computationally. In a case where the actuation element comprises a lifting magnet, damage to electrical lines, for example cable breakage, can be detected via an increased electrical resistance.

In one embodiment, the actuation element state parameter describes an actuation latency of the actuation element, and the actuation element threshold value describes a maximum permissible actuation latency. An actuation latency is understood to be the time between the closing of the switching element and the start of movement or the reaching of a defined position by the actuation element. The defined position is for example a target position. In the case where the actuation element comprises a shape memory alloy, functional fatigue is characterised by the loss of the shape memory and is usually characterised by a significant increase in the transformation temperatures, which is expressed by an extended time interval between the start of the current flow and the start of the phase transformation, in other words the change in length. The time at which the change in length of the shape memory alloy wire begins can be determined for example by way of the maximum of the electrical resistance of the shape memory alloy wire. A deterioration in the response of the actuator can thus be determined in a simple manner.

Furthermore, the actuation element state parameter may describe a voltage drop across the actuation element, and the actuation element threshold value may describe a maximum permissible voltage drop. Several variants are conceivable here. On the one hand, the voltage drop itself can be used as an indicator of an ageing or wear state. This is particularly the case if an associated current is subject to only slight fluctuations or is known. Alternatively, it is conceivable to use the voltage drop to calculate the electrical resistance.

In one variant, the actuation element state parameter describes an actuating force of the actuation element, and the actuation element threshold value describes a minimum permissible actuating force. Alternatively or additionally, the bias element state parameter describes a bias force of the bias element, and the bias element threshold value describes a minimum permissible bias force. This ensures that either the actuation element and/or the bias element have an actuating force or bias force which is sufficient for reliable operation of the emergency brake unit, or a blocking signal is triggered. Overall, the emergency brake unit is highly reliable.

In another variant, the energy storage unit state parameter describes a storage capacity of the energy storage unit, and the energy storage unit threshold value describes a minimum permissible storage capacity. As explained previously, energy stored in the energy storage unit is used to supply the actuation element. This ensures that the storage capacity, which may be subject to ageing or wear, is sufficient for reliable operation of the emergency brake unit.

At least one of the energy storage unit state parameter, the actuation state parameter and the bias element state parameter may be detected during a test routine. Alternative terms for a test routine are test operation, test sequence, verification routine and self-test. The test routine is to be distinguished from the operation of the emergency brake unit. The test routine is carried out before the actual operation or before a predetermined portion of operation to ensure that the respectively detected state parameters are within the normal range. Otherwise, no operation is possible. The test routine is carried out for example after each activation of the emergency brake unit, after each use of the tool, before each use of the tool, or regularly during work breaks or temporary interruptions in the operation of the tool.

As part of a test routine, the energy storage unit may be fully or partially charged and then discharged again. In this way, the storage capacity of the energy storage unit can be determined.

In a case where the actuation element comprises a shape memory alloy in the form of a wire, it is possible to apply a comparatively small current, in other words relatively low energy, to the shape memory alloy as part of a test routine and to measure a stroke or a voltage drop after a particular time. These values can be compared with respectively assigned target values.

The test routine may also include a check as to whether a cutting element is mounted in the tool. As explained previously, the cutting element is for example a saw blade.

The test routine may also include checking a mechanical component of the emergency brake unit for wear. In this context, for example the state of wear of the brake pads of the emergency brake unit can be determined. The state of wear of the brake pad or pads can be determined, for example, by applying the brake to the capacitively coupled saw blade. The thickness of the brake pad influences the capacitive coupling between the saw blade and the brake, and so a conclusion can be drawn about the wear of the brake pad.

In one variant, the method further comprises providing at least one of the energy storage unit state parameter, the actuation element state parameter and the bias element state parameter for a user. An overall state aggregated from at least two of the energy storage unit state parameter, the actuation element state parameter and the bias element state parameter may also be provided. This may be provided via an interface which is not directly readable by a human, for example by Bluetooth or WLAN. For this purpose, a smartphone or another electronic device may be coupled to an interface of the emergency brake unit. Alternatively, a human-readable communication interface, for example a display, may be provided on the emergency brake unit or on the tool equipped with it. In an illustrative example, a user can be informed in this way of triggerings of the emergency brake unit which have already occurred and/or of the triggerings which are still available. On this basis, the user can plan his work with the tool well. Furthermore, trust in the reliability of the emergency brake unit and the tool equipped with it is strengthened.

The method may also include triggering a warning signal if at least one of the energy storage unit state parameter, the actuation element state parameter and the bias element state parameter is within the respectively assigned standard range and within an assigned warning range. In particular, the warning range is at one end of the standard range, which corresponds to comparatively high wear or comparatively high ageing. The user of the emergency brake unit and of the tool equipped therewith thus receives a warning that it may soon no longer be possible to operate the emergency brake unit, and can therefore prepare for this.

In addition, the object is achieved by a monitoring unit for monitoring a state of an emergency brake unit for a motor-driven tool. The emergency brake unit has an actuator with an actuation element and at least one electrical energy storage unit, which is electrically coupled to the actuation element via an electrical switching element, in such a way that the actuation element can be selectively supplied with electrical energy stored in the energy storage unit by actuating the switching element. The monitoring unit comprises at least one state sensor, which is designed to detect an energy storage unit state parameter which characterises a state of the energy storage unit. Alternatively or additionally, the state sensor is designed to detect an actuation element state parameter which characterises a state of the actuation element. In addition, the monitoring unit comprises a storage unit, on which at least one of an energy storage unit threshold value and an actuation element threshold value is stored, which limits a respectively assigned standard range. The monitoring unit also includes a computing unit, which is designed to compare the energy storage unit state parameter detected by the state sensor with the energy storage unit threshold value. Alternatively or additionally, the computing unit is designed to compare the detected actuation element state parameter with the actuation element threshold value. The monitoring unit also includes a communication interface for triggering a blocking signal. The monitoring unit can therefore be used to monitor a state of at least one of the energy storage unit and the actuation element. The actuator of the emergency brake unit and thus the emergency brake unit as a whole can only be operated if the state parameter describing the state is within an associated standard range, which may also be referred to as the normal range. Otherwise, the operation of the actuator and thus of the emergency brake unit is blocked. In this way, the reliability of the emergency brake unit is increased because it can only be operated if a corresponding state within the respectively assigned standard range has been detected for all state parameters to be detected. This applies in particular if the emergency brake unit is an emergency brake unit which can be triggered multiple times. In this variant, it is ensured that the emergency brake unit is in a suitable state each time it is triggered. In the case of emergency brake units which can be triggered multiple times, it may also be said in this context that an ageing state or state of wear resulting from previous triggerings is monitored. As far as triggering a blocking signal is concerned, the alternatives already explained in connection with the method according to the invention are again available. Overall, the monitoring unit increases the reliability of an associated emergency brake unit.

If the state to be detected by the monitoring unit relates to the actuation processes of the energy storage unit, the state sensor may be an electrical current sensor or an electrical voltage sensor which detects a current flowing across a system boundary of the energy storage unit or a voltage falling across the energy storage unit over time. Current and voltage curves of this type can be evaluated to determine a number of actuation processes. In the case of the detected electrical current, a direction of current flow may also be taken into account. In this context, for example, crossings of particular threshold values are counted and used as indicators of actuation processes.

If the state to be detected by the monitoring unit relates to the storage capacity of the energy storage unit, the state sensor may be an electrical current sensor which detects a current flowing across a system boundary of the energy storage unit over time. To determine the storage capacity, the energy storage unit can be fully charged once and fully discharged once, for example as part of a test routine. The storage capacity can be determined from the current curve which occurs.

If the state to be detected by the monitoring unit relates to the voltage drop across the actuation element, the state sensor may be an electrical voltage sensor which detects a voltage drop across the actuation element over time.

If the state to be detected by the monitoring unit relates to the electrical resistance of the actuation element, the state sensor may be a combination of an electrical current sensor and an electrical voltage sensor. This means that a current flowing across a system boundary of the actuation element and a voltage dropping across the actuation element can be detected over time. The electrical resistance can be calculated using these values.

If the state to be detected by the monitoring unit relates to the actuation processes of the actuation element, the state sensor may also be an electrical current sensor or an electrical voltage sensor which detects a current flowing across a system boundary of the actuation element or a voltage falling across the actuation element over time. Current and voltage curves of this type can be evaluated to determine a number of actuation processes. In this context, for example, crossings over particular threshold values are counted and used as indicators for actuation processes. Alternatively or additionally, the current and voltage curves may be used to determine an ageing state of the actuation element, for example by counting crossings over particular current or voltage threshold values and using them as indicators for the ageing of the actuation element.

If the state to be detected by the monitoring unit relates to a position or position difference of the actuation element, the state sensor may be a position sensor. This includes both position sensors which can detect an absolute position and position sensors which can only detect a relative position.

If the state to be detected by the monitoring unit relates to an actuating force of the actuation element, the state sensor may be a force sensor.

If the state to be detected by the monitoring unit relates to the actuation latency of the actuation element, the state sensor may also be an electrical current sensor or an electrical voltage sensor which detects a current flowing across a system boundary of the actuation element or a voltage falling across the actuation element over time. These current and voltage curves can be used to determine the actuation latency. Optionally, the position sensor and/or the force sensor mentioned above may also be used.

Alternatively or additionally, the state sensor may be a trigger control unit for detecting that a user is coming into contact with the saw blade or that contact of this type is imminent, which for example comprises a capacitive sensor. In this way, for example during the test routine, the time period from the triggering of the emergency brake unit to the contact of the brake, in particular the brake cam, with the saw blade, in other words the actuation latency of the emergency brake unit as a whole, can be determined.

The monitoring unit may also comprise a state sensor configured to determine a state of a bias element of the actuator of the emergency brake unit.

If the state to be detected by the monitoring unit relates to the conductivity of the bias element, the state sensor may be an electrical current sensor which detects a current flowing across a system boundary of the bias element. The conductivity can be determined on the basis of the magnitude of the measured current.

If the state to be detected by the monitoring unit relates to a bias force of the bias element, the state sensor may be a force sensor.

It will be appreciated that the state sensor may also comprise any combination of the mentioned sensors.

The object is further achieved by an emergency brake unit for a motor-driven tool. The emergency brake unit comprises a monitoring unit according to the invention. A state of at least one of the energy storage unit and the actuation element, in other words the functional core elements of the emergency brake unit, can thus be monitored. The actuator of the emergency brake unit and thus the emergency brake unit as a whole can only be operated if the state parameter describing the state lies within an associated standard range, which may also be referred to as the normal range. Otherwise, the operation of the actuator and thus of the emergency brake unit is blocked. In this way, the reliability of the emergency brake unit is increased.

It will be appreciated that the effects and advantages mentioned in relation to any one of the inventive method, the inventive monitoring unit and the inventive emergency brake unit also apply to any other of the inventive method, the inventive monitoring unit and the inventive emergency brake unit.

The invention is explained in the following with reference to various embodiments, which are shown in the accompanying drawings, in which:

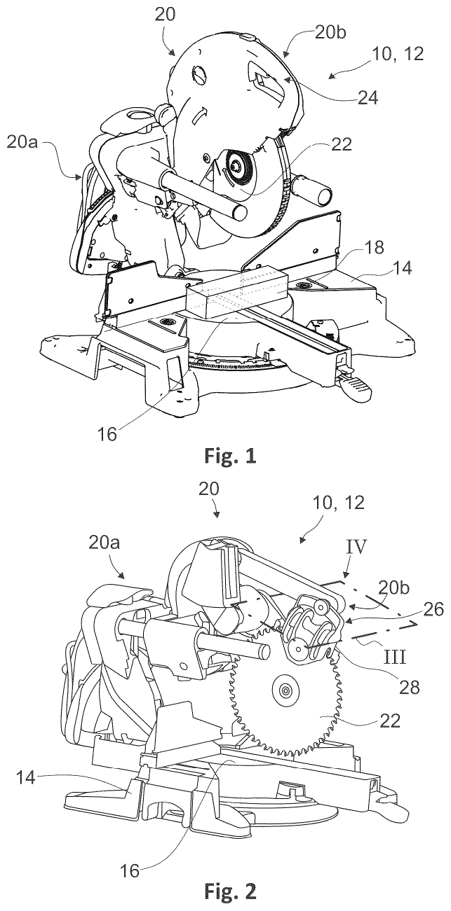

FIG. 1 shows a sawing device with an emergency brake unit according to the invention, which is equipped with a monitoring unit according to the invention and an actuator, the emergency brake unit being operable by a method according to the invention,

FIG. 2 shows the sawing device of FIG. 1, with a housing part and a protective cover omitted,

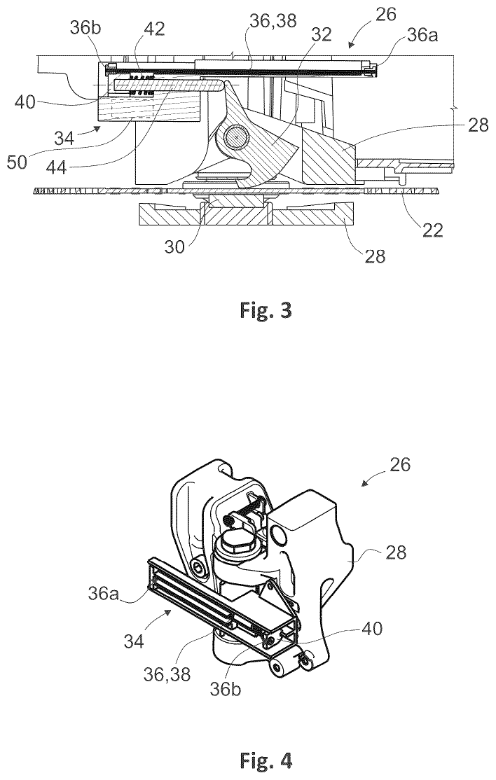

FIG. 3 is a section through the sawing device of FIG. 2 along the plane III,

FIG. 4 shows the emergency brake unit in an isolated representation in a view along the direction IV in FIG. 2,

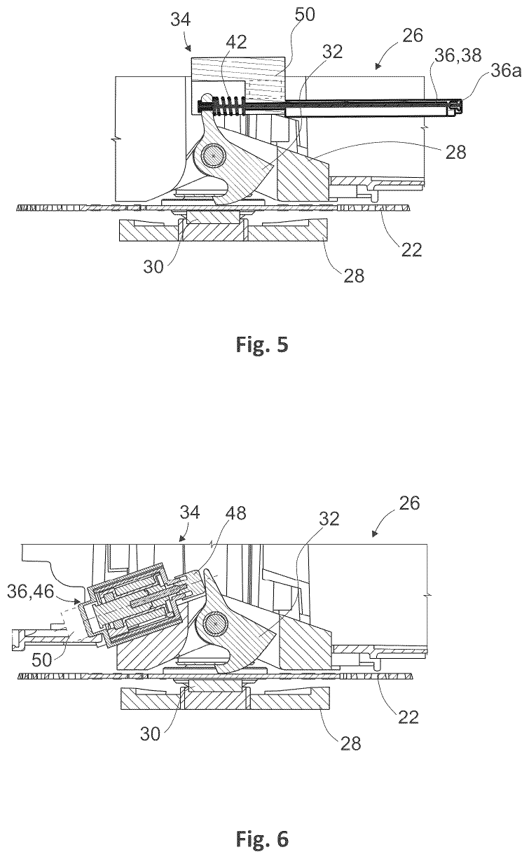

FIG. 5 shows an alternative embodiment of the emergency brake unit in a view corresponding to FIG. 3,

FIG. 6 shows a further alternative embodiment of the emergency brake unit in a view corresponding to FIG. 3, and

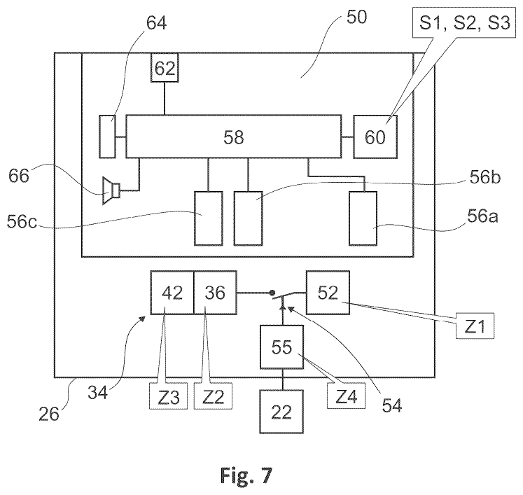

FIG. 7 is a schematic view of the emergency brake unit according to the invention as well as its actuator and the monitoring unit according to the invention.

FIGS. 1 and 2 show a motor-driven tool 10, which in the example shown is a sawing device 12, more precisely a mitre saw.

The sawing device 10 comprises a base part 14, which has a support surface 16 for a workpiece 18. The workpiece 18 is to be understood as exemplary.

The sawing device 12 also has a pivot device 20 which is mounted in an articulated manner on the base part 14 at a first portion 20a. A disc-shaped saw blade 22 is mounted on a second portion 20b which is spaced apart from the first portion 20a. A handle 24 is also provided on the second portion 20b.

A user of the sawing device 12 can thus, by means of the handle 24, bring the saw blade 22 in a rotating state into interaction with the workpiece 18 mounted on the support surface 16, in such a way that the workpiece is sawn or sawn off.

The sawing device 12, in other words the motor-driven tool 10, is further equipped with an emergency brake unit 26.

The emergency brake unit 26 is designed to brake the saw blade 22 to a standstill if, in a state in which the saw blade 22 is rotating, it is detected that a user is coming into contact with the saw blade 22 or that contact of this type is imminent.

In this context, the saw blade 22 is used as a capacitive sensor element, in other words an electrical capacitance of the saw blade 22 is continuously detected. In the case where the electrical capacitance is outside a predetermined normal range, contact is detected. This example is to be understood as exemplary. Other, for example optical, methods for detecting that a user is coming into contact with the saw blade 22 or that contact of this type is imminent are also conceivable.

The emergency brake unit 26 can be seen in detail in several variants in FIG. 3 to 6.

In all variants, the emergency brake unit 26 has a brake calliper 28, which engages over an edge of the saw blade 22, in such a way that a pressure element 30 provided on the brake calliper 28 is arranged on a first axial side of the saw blade 22 and a brake cam 32 rotatably mounted on the brake calliper 28 is arranged on a second axial side of the saw blade 22.

The brake cam 32 is coupled to an actuator 34, by means of which the brake cam 32 can be selectively rotated in such a way that it presses the saw blade 22 against the pressure element 30 and as a result brakes it to a standstill.

In the variant of FIGS. 3 and 4, the actuator 34 comprises an actuation element 36 which comprises a shape memory alloy 38. In particular, the actuation element 36 is designed as a wire which is made of the shape memory alloy 38.

The actuation element 36 is fastened at a first end 36a to a fastening receptacle. The fastening receptacle may be part of the brake calliper 28 or part of a holding structure fixed to the brake calliper 28. The other end 36b of the actuation element 36 is fastened to a carriage 40, which is mounted displaceable in translation with respect to the brake calliper 28. The carriage 40 is subjected to a force by means of a bias element 42 in a direction which corresponds to a tensile load on the actuation element 36. In the present case, the bias element 42 is designed as a spiral spring.

Furthermore, the carriage 40 is coupled to the brake cam 32 via an actuation pin 44.

If the actuation element 34 is supplied with an electrical current of sufficient magnitude, a thermally induced lattice transformation of the shape memory alloy 38 takes place, and results in the actuation element 36 shortening. This results in a displacement of the carriage 40 and the actuation pin 44 to the right side in FIG. 3, in other words counter to the bias of the bias element 42. As a result, the brake cam 32 is brought into engagement with the saw blade 22 and brakes it to a standstill.

FIG. 5 shows an alternative embodiment of the actuator 34. In this embodiment, the first end 36a of the actuation element 36, which is designed as a wire made of shape memory alloy 38, is fixed relative to the brake calliper 28 as usual.

Unlike in the variant of FIGS. 3 and 4, however, the second end 36b is attached directly to the brake cam 32. The brake cam 32 is subjected to force by means of a bias element 42. The loading direction again corresponds to a tensile loading direction for the actuation element 36.

The bias element 42 is again a spiral spring.

If, in the variant of FIG. 5, the actuation element 36 is supplied with an electrical current of sufficient magnitude, a thermally induced lattice transformation of the shape memory alloy 38 takes place, and results in the actuation element 36 becoming shorter. This results in a rotation of the brake cam 32 in such a way that it is brought into engagement with the saw blade 22 and brakes it to a standstill. In FIG. 5, the brake cam 30 rotates clockwise when the emergency brake is triggered.

FIG. 6 shows a further variant, in which the brake cam 32 corresponds to the brake cam 32 of FIG. 3.

The essential difference from the variants of FIG. 2 to 5 is that the actuation element 36 is now designed as a lifting magnet 46, the plunger 48 of which acts directly on the brake cam 32.

If, in this variant, the actuation element 36, in other words the lifting magnet 46, is supplied with an electric current of sufficient magnitude, the plunger 48 moves to the right in FIG. 6. This results in a rotation of the brake cam 32, clockwise in the illustration of FIG. 6, in such a way that it is brought into engagement with the saw blade 22 and brakes it to a standstill.

In all variants, the emergency brake unit 26 comprises a monitoring unit 50, which is only shown schematically in FIG. 3 to 6. This can be seen in detail together with the other components of the actuator 34 in FIG. 7.

The emergency brake unit 26, the actuation element 36 of which was shown in FIG. 3 to 6, further comprises an electrical energy storage unit 52, which can be designed as a battery or capacitor.

The electrical energy storage unit 52 is coupled to the actuation element 36 via an electrical switching element 54, in such a way that the actuation element 36 can be selectively supplied with electrical energy stored in the energy storage unit 52 by actuating the switching element 54. In other words, by actuating the switching element 54, the wire made of shape memory alloy 38 or the lifting magnet 46 is energised, depending on the embodiment. An amount of charge provided in the energy storage unit 52 is used for this purpose.

The monitoring unit 50 is designed to monitor a state of the emergency brake unit 26.

For this purpose, the monitoring unit 50 comprises a first state sensor 56a, which is designed to detect an energy storage unit state parameter Z1 which characterises a state of the energy storage unit 52.

In the embodiment shown, the monitoring unit 50 further comprises a second state sensor 56b, which is designed to detect an actuation element state parameter Z2 which characterises a state of the actuation element 36.

Furthermore, in the present example, the monitoring unit 50 comprises a third state sensor 56c, which is designed to detect a bias element state parameter Z3 which characterises a state of the bias element 42.

All state sensors 56a, 56b, 56c are signal-coupled to a computing unit 58 of the monitoring unit 50.

The computing unit 58 is also signal-coupled to a storage unit 60.

In this context, the computing unit 58 is designed to receive the energy storage unit state parameter Z1, actuation element state parameter Z2 and bias element state parameter Z3 detected by means of the respectively assigned state sensors 56a, 56b, 56c.

Furthermore, the computing unit 58 is designed to receive an energy storage unit threshold value S1 assigned to the energy storage unit state parameter Z1, to receive an actuation element threshold value S2 assigned to the actuation element state parameter Z2, and to receive a bias element threshold value S3 assigned to the bias element state parameter Z3 from the storage unit 60.

The energy storage unit threshold value S1, the actuation element threshold value S2 and the bias element threshold value S3 are stored on the storage unit 60.

The energy storage unit threshold value S1 limits a standard range of the energy storage unit state parameter Z1. The actuation element threshold value S2 limits a standard range of the actuation element state parameter Z2. The bias element threshold value S3 limits a standard range of the bias element state parameter Z3.

Furthermore, the computing unit 58 is designed to compare the energy storage unit state parameter Z1, the actuation element state parameter Z2 and the bias element state parameter Z3, which are detected by means of the respectively assigned state sensors 56a, 56b, 56c, with the respectively associated ones of the energy storage unit threshold value S1, the actuation element threshold value S2 and the bias element threshold value S3.

In addition, the monitoring unit 50 comprises a communication interface 62, which is signal-coupled to the computing unit 58.

As will be explained in greater detail below, a blocking signal, which causes the actuator 34 and thus the emergency brake unit 26 to be inoperable, can be triggered via the communication interface 62.

In the example shown, the first state sensor 56a comprises an electrical current sensor and an electrical voltage sensor. A current flowing across a system boundary of the energy storage unit 52 and a voltage dropping across the energy storage unit 52 can thus be detected over time.

On the basis of these current and voltage curves, a number of actuation processes can be determined by means of the computing unit 58. In this case, crossings of the measured current over a particular threshold value provided by the storage unit 60 are counted and used as indicators for actuation processes.

Furthermore, the computing unit 58 is designed to determine a storage capacity of the energy storage unit 52 on the basis of the detected current profile.

The second state sensor 56b also comprises an electrical current sensor and an electrical voltage sensor. A current flowing across a system boundary of the actuation element 36 and a voltage dropping across the actuation element 36 can thus be detected over time.

In this context, the voltage drop itself can be used to monitor the state of the actuation element 36.

Furthermore, an electrical resistance of the actuation element 36 can be calculated on the basis of the determined voltage curve and the determined current curve, and can be used as the actuation element state parameter Z2.

As explained previously in connection with the energy storage unit 52, a number of actuation processes can also be determined for the actuation element 36 on the basis of the current and voltage curves by means of the computing unit 58.

In the embodiment shown, the second state sensor 56b further comprises a position sensor, by means of which a position of the second end 36b of the actuation element 36 in the form of a wire made of shape memory alloy 38 can be detected. If the actuation element 36 is designed as a lifting magnet 46 (see FIG. 6), a position of the plunger 48 can be detected by means of the position sensor.

In addition, the second state sensor 56b comprises a force sensor. By means of the force sensor, an actuating force of the actuation element 36 can be detected.

The current sensor or the voltage sensor can also detect an actuation latency of the actuation element 36 in combination with the position sensor or the force sensor. A desired start of actuation in the form of a voltage change or a current change is detected by means of the voltage sensor or the current sensor. An actual start of movement of the actuation element 36 is detected by means of the position sensor or the force sensor. The time period in between is the actuation latency. In this context, the computing unit 58 is designed to carry out the above steps for calculating the actuation latency.

Alternatively, the actuation latency can be determined by means of a state sensor, which is or comprises a trigger control unit 55. This is designed to detect during operation that a user is coming into contact with the saw blade 22 or that contact of this type is imminent. The trigger control unit 55 comprises for example a capacitive sensor. The capacitive sensor serves to detect contact or approach of an electrically conductive medium, for example the skin of a user of the emergency brake unit 26. The trigger control unit 55 can thus take on a “triggered” and an “untriggered” state. This can be regarded as a trigger control unit state parameter Z4.

The trigger control unit state parameter ZA can also be used as part of the test routine. In this context, the trigger control unit 55 is switched from the “untriggered” to the “triggered” state in a defined manner by means of a test trigger, without contact with the saw blade 22 being detected by the capacitive sensor. Rather, the capacitive sensor is used to detect contact between the brake, in particular the brake cam 32, and the saw blade 22. In this way, during the test routine, the time period from the test triggering of the emergency brake unit 26, in other words from the time at which the trigger control unit state parameter Z4 switches from “untriggered” to “triggered”, to the contact of the brake, in particular the brake cam 32, with the saw blade 22, in other words to the time at which the trigger control unit switches from “no contact with the saw blade” to “contact with the saw blade”, in other words the actuation latency of the emergency brake unit 26 as a whole, can be determined.

The third state sensor 56c may also comprise an electrical current sensor. If a current value detected in this way is compared with a bias element threshold value S3 stored in the storage unit 60, a conductivity of the bias element 42 can be determined.

In addition, the third state sensor 56c comprises a force sensor. In this way, a bias force of the bias element 42 can be detected.

The monitoring unit 50 is also equipped with a user interface 64, which is signal-coupled to the computing unit 58. Each of the energy storage unit state parameter Z1, the actuation element state parameter Z2 and the bias element state parameter Z3 can be provided to a user of the tool 10 via the user interface 64. The energy storage unit threshold value S1, the actuation element threshold value S2 and the bias element threshold value S3 may optionally also be provided to the user. In the present example, the user interface 64 is designed as a display.

In addition, the monitoring unit 50 comprises a warning unit 66, which is also signal-coupled to the computing unit 58. A warning signal can be issued by means of the warning unit 66. In the present case, the warning unit 66 is designed as a loudspeaker. It will be appreciated, however, that this is merely an example.

Alternatively, the warning unit 66 and the user interface 64 can be formed by a shared display. In this example, the warning unit 66 is designed to output optical warning signals.

The actuator 34 can be operated by a method for operating an actuator of an emergency brake unit for a motor-driven tool.

As part of the method, the energy storage unit state parameter Z1 is detected, which characterises a state of the energy storage unit 52.

In addition, the actuation element state parameter Z2 is detected, which characterises a state of the actuation element 36.

Furthermore, the bias element state parameter Z3 is detected, which characterises a state of the bias element 42.

Subsequently, an energy storage unit threshold value S1 assigned to the energy storage unit state parameter Z1, a state parameter threshold value S2 assigned to the actuation element state parameter Z2, and a bias element threshold value S3 assigned to the bias element state parameter Z3 are obtained from the storage unit 60.

In addition, by means of the computing unit 58, the energy storage unit state parameter Z1 is compared with the energy storage unit threshold value S1, the actuation element state parameter Z2 is compared with the actuation element threshold value S2 and the bias element state parameter Z3 is compared with the bias element threshold value S3.

Thus, the energy storage unit threshold value S1 is assigned to the energy storage unit state parameter Z1, the actuation element threshold value S2 to the actuation element state parameter Z2, and the threshold value S3 to the state parameter S3.

The energy storage unit threshold value S1 limits a standard range of the energy storage unit state parameter Z1, the actuation element threshold value S2 limits a standard range of the actuation element state parameter Z2 and the bias element threshold value S3 limits a standard range of the bias element state parameter Z3.

For reliable operation of the emergency brake unit 26, each of the energy storage unit state parameter Z1, the actuation element state parameter Z2 and the bias element state parameter Z3 must be within the respectively assigned standard range.

Accordingly, a blocking signal is triggered by the method if one of the energy storage unit state parameter Z1, the actuation element state parameter Z2 and the bias element state parameter Z3 is outside the normal range. The emergency brake unit 26 then cannot be operated.

In the case where one of the energy storage unit state parameter Z1, the actuation element state parameter Z2 and the bias element state parameter Z3 is within the standard range but also within an associated warning range, the method provides for a warning signal to be issued by means of the warning unit 66. The warning range is selected within the respectively assigned standard range in such a way that an energy storage unit state parameter Z1, actuation element state parameter Z2 and/or bias element state parameter Z3 lying within the warning range indicates an imminent loss of reliability.

In addition, as part of the method, the determined energy storage unit state parameter Z1, the determined actuation element state parameter Z2 and the determined bias element state parameter Z3 are provided to the user of the tool 10 by means of the user interface 64.

The energy storage unit threshold S1, the actuation element threshold S2 and the bias element threshold S3 are also provided to the user of the tool 10 via the user interface 64.

As explained previously in connection with the monitoring unit 50, the energy storage unit state parameter Z1, which characterises a state of the energy storage unit 52, may be a number of actuation processes of the energy storage unit 52 which have already taken place and/or a storage capacity of the energy storage unit 52. The energy storage unit threshold value S1 accordingly describes a maximum permissible number of actuation processes and/or a minimum permissible storage capacity.

As explained previously in connection with the monitoring unit 50, the actuation element state parameter Z2, which characterises a state of the actuation element 36, may be a number of actuation processes of the actuation element 36 which have already taken place, a position of the actuation element 36, an electrical resistance of the actuation element 36, an actuation latency of the actuation element 36, a voltage drop across the actuation element 36 and/or an actuating force of the actuation element 36. The actuation element threshold value S2 accordingly describes a number of maximum permissible actuation processes, a target position. a maximum permissible electrical resistance, a maximum permissible actuation latency, a maximum permissible voltage drop and/or a minimum necessary actuating force of the actuation element 36.

As also explained previously in connection with the monitoring unit 50, the bias element state parameter Z3, which characterises a state of the bias element 42, may be a conductivity of the bias element 42 and/or a bias force of the bias element 42. The bias element threshold value S3 accordingly describes a minimum permissible conductivity and/or a minimum permissible bias force.

In the present example, the method is carried out as part of a test routine which runs whenever the tool 10 is switched on. During the test routine, the energy storage unit state parameter Z1 characterising the state of the energy storage unit 52, the actuation element state parameter characterising the actuation element 36 and the bias element state parameter Z3 characterising the bias element 42 are detected. The emergency brake unit 26 can only be operated if all of the energy storage unit state parameter Z1, the actuation element state parameter Z2 and the bias element state parameter Z3 are within the respectively assigned standard ranges.

In the example explained above, the monitoring unit 50 comprises a large number of state sensors. Accordingly, a large number of state parameters can be detected. It will be appreciated that the monitoring unit 50 may also contain only a selection which includes one or more of the sensors explained above. Accordingly, only one or more of the state parameters explained above can be monitored. The method for operating the actuator can therefore also be carried out with only a selection of state parameters which includes one or more state parameters.

The above explanations relate to a sawing device 10 in the form of a mitre saw. It will be appreciated, however, that the design as a mitre saw is only an example and the above statements also apply to sawing devices of other designs, for example band saws.

### LIST OF REFERENCE NUMERALS

10 Tool
12 Sawing device
14 Base part
16 Support surface
18 Workpiece
20 Pivot device
20a First portion
20b Second portion
22 Saw blade
24 Handle
26 Emergency brake unit
28 Brake calliper
30 Pressure element
32 Brake cam
34 Actuator
36 Actuation element
36a First end
36b Second end
38 Shape memory alloy
40 Carriage
42 Bias element
44 Actuation pin
46 Lifting magnet
48 Piston
50 Monitoring unit
52 Electrical energy storage unit
54 Electrical switching element
55 Trigger control unit
56a First state sensor
56b Second state sensor
56c Third state sensor
58 Computing unit
60 Storage unit
62 Communication interface
64 User interface
66 Warning unit
S1 Energy storage unit threshold
S2 Actuation element threshold
S3 Bias element threshold
Z1 Energy storage unit state parameter
Z2 Actuation element state parameter
Z3 Bias element state parameter
Z4 Actuation element state parameter

1. A method for operating an emergency brake unit for a motor-driven tool, wherein the emergency brake unit has an actuator with an actuation element and at least one electrical energy storage unit, which is electrically coupled to the actuation element via an electrical switching element, in such a way that the actuation element is configured to be selectively supplied with electrical energy stored in the energy storage unit by actuating the switching element, the method comprising:
detecting an energy storage unit state parameter (Z1) which characterises a state of the energy storage unit and/or an actuation element state parameter (Z2) which characterises a state of the actuation element,
comparing the detected energy storage unit state parameter (Z1) with an energy storage unit threshold value (S1) which limits a standard range assigned to the energy storage unit state parameter (Z1), and/or comparing the detected actuation element state parameter (Z2) with an actuation element threshold value (S2) which limits a standard range assigned to the actuation element state parameter (Z2),
triggering a blocking signal if at least one selected from the group consisting of the detected energy storage unit state parameter (Z1) and the detected actuation element state parameter (Z2) is outside the respectively assigned standard range.

2. The method according to claim 1, wherein the actuator comprises a bias element and wherein the method comprises:
detecting a bias element state parameter (Z3) which characterises a state of the bias element,
comparing the bias element state parameter (Z3) with a bias element threshold value (S3) which limits a standard range assigned to the bias element state parameter (Z3),
triggering a blocking signal when the bias element state parameter (Z3) is outside the normal range.

3. The method according to claim 2, wherein the bias element state parameter (Z3) describes a conductivity of the bias element, and the bias element threshold value (S3) describes a minimum permissible conductivity.

4. The method according to claim 1, wherein the energy storage unit state parameter (Z1) describes a number of actuation processes of the energy storage unit which have already taken place, and the energy storage unit threshold value (S1) describes a maximum permissible number of actuation processes, and/or
wherein the actuation element state parameter (22) describes a number of actuating operations of the actuation element which have already taken place, and the actuation element threshold value (S2) describes a number of maximum permissible actuating operations.

5. The method according to claim 1, wherein the actuation element state parameter (Z2) describes a position or position difference of the actuation element, and the actuation element threshold value (S2) describes a desired position or a desired position difference.

6. The method according to claim 1, wherein the actuation element state parameter (Z2) describes an electrical resistance of the actuation element, and the actuation element threshold value (S2) describes a maximum permissible electrical resistance.

7. The method according to claim 1, wherein the actuation element state parameter (Z2) describes an actuation latency of the actuation element, and the actuation element threshold value (S2) describes a maximum permissible actuation latency.

8. The method according to claim 1, wherein the actuation element state parameter (Z2) describes a voltage drop across the actuation element, and the actuation element threshold value (S2) describes a maximum permissible voltage drop.

9. The method according to claim 2, wherein the actuation element state parameter (Z2) describes an actuating force of the actuation element, and the actuation element threshold value (S2) describes a minimum permissible actuating force, and/or
wherein the bias element state parameter (Z3) describes a bias force of the bias element, and the bias element threshold value (S3) describes a minimum permissible bias force.

10. The method according to claim 1, wherein the energy storage unit state parameter (Z1) describes a storage capacity of the energy storage unit, and the energy storage unit threshold value (S1) describes a minimum permissible storage capacity.

11. The method according to claim 2, wherein at least one selected from the group consisting of the energy storage unit state parameter (Z1), the actuation element state parameter (Z2) and the bias element state parameter (Z3) is detected during a test routine.

12. The method according to claim 2, further comprising providing at least one selected from the group consisting of the energy storage unit state parameter (Z1), the actuation element state parameter (Z2) and the bias element state parameter (Z3) to a user.

13. The method according to claim 2, further comprising triggering a warning signal if at least one selected from the group consisting of the energy storage unit state parameter (Z1), the actuation element state parameter (Z2) and the bias element state parameter (Z3) is within the respectively assigned standard range and within an assigned warning range.

14. A monitoring unit for monitoring a state of an emergency brake unit for a motor-driven tool, wherein the emergency brake unit has an actuator with an actuation element and at least one electrical energy storage unit, which is electrically coupled to the actuation element via an electrical switching element, in such a way that the actuation element is configured to be selectively supplied with electrical energy stored in the energy storage unit by actuating the switching element, the monitoring unit comprising:
at least one state sensor which is designed to detect an energy storage unit state parameter (Z1) which characterises a state of the energy storage unit and/or to detect an actuation element state parameter (Z2) which characterises a state of the actuation element,
a storage unit, on which at least one selected from the group consisting of an energy storage unit threshold value (S1) and an actuation element threshold value (S2) is stored, which limits a respectively assigned standard range,
a computing unit, which is designed to compare the energy storage unit state parameter (Z1) detected by the state sensor with the energy storage unit threshold value (S1) and/or to compare the detected actuation element state parameter (Z2) with the actuation element threshold value (S2), and
a communication interface for triggering a blocking signal.

15. An emergency brake unit for a motor-driven tool comprising a monitoring unit according to claim 14.
